(19) United States
(12) Patent Application Publication
(10) Pub. No.: US 2025/0135734 A1
(43) Pub. Date: May 1, 2025

(54) SYSTEMS AND METHODS FOR RESIN FLOW FRONT DETECTION DURING HIGH PRESSURE RESIN TRANSFER MOLDING OF COMPOSITE PARTS

(71) Applicants: GM GLOBAL TECHNOLOGY OPERATIONS LLC, Detroit, MI (US); Coats American Inc, Marion, NC (US)

(72) Inventors: Selina Xinyue Zhao, Rochester Hills, MI (US); Venkateshwar R. Aitharaju, Troy, MI (US); George Han, Marion, NC (US); Colin Rowbottom, Marion, NC (US)

(21) Appl. No.: 18/495,227

(22) Filed: Oct. 26, 2023

(51) Int. Cl. B29C 70/54; B29C 70/48; B29K 105/08; B29K 307/04; G01V 3/02

(52) U.S. Cl. CPC B29C 70/546; B29C 70/48; G01V 3/02; B29K 2105/0872; B29K 2307/04

(57) ABSTRACT

A system and method for molding a fiber reinforced composite part are disclosed. The system includes a mold with electrical contacts that make electrical contact with at least one monitoring circuit incorporated in a fiber preform disposed in the mold so that the resistance of the monitoring circuit can be monitored as resin fills the mold cavity and envelopes the preform. The method includes monitoring the resistance of at least one monitoring circuit incorporated into a fiber preform disposed in a mold to determine the location of the resin flow front as resin is injected into the mold and surrounds the fiber preform.

### GOVERNMENT CLAUSE

This invention was made with government support under Grant No. DE-EE0009204 awarded by the U.S. Department of Energy. The Government has certain rights in this invention.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

This disclosure relates to systems and methods for molding composite parts, and in particular to systems and methods for resin flow front detection during high pressure resin transfer molding of composite parts.

Some methods of molding composite parts involves the injection of resin into a mold cavity containing a fiber preform. Because the mold is closed, the extent of the resin fill can be difficult to determine, and thus the part rejection rate can be relatively high.

### SUMMARY

Embodiments of this disclosure provide systems for resin flow front detection during resin transfer molding of composite parts. According to a first embodiment, the system comprises a part mold having a plurality of mold sections that operate between an open configuration and an operational configuration in which the mold sections form a mold cavity with an interior surface substantially the shape of the composite part. There is preferably at least one set of electrical contacts on the surface of the mold cavity for making electrical contact with at least one monitoring circuit that can be positioned inside the mold cavity. This monitoring circuit can be incorporated into, but electrically isolated from, a fibrous composite part preform that can placed into the mold cavity prior to the injection of the resin. An electrical resistance measurement circuit can be connected to the at least one set of electrical contacts on the mold surface, to measure the electrical resistance of the at least one monitoring circuit in the mold cavity connected to the set of electrical contacts on the surface of the mold cavity.

The resistance of the monitoring circuits has been found to change as resin is injected into the mold cavity and contacts the monitoring circuits. The change of the resistance of the monitoring circuits, together with information about the mold cavity geometry and resin flow path and resin properties allows the determination of the location of a resin flow front during resin transfer molding of composite parts.

According to a second embodiment of this disclosure, the system comprises a part mold and fiber part preform disposed therein. The mold can comprise a plurality of mold sections which together define an interior mold cavity with a surface substantially corresponding to the shape of a composite part to be manufactured. The part mold can have at least one set of electrical contacts on the inside surface of the part mold. A fiber preform for the composite part is disposed in the mold cavity, and includes a plurality of reinforcing fibers and at least one monitoring circuit whose resistance changes as the circuit is surrounded with resin. The at least one monitoring circuit has electrical contacts positioned on the preform so that when the preform is properly seated in the mold cavity, and the mold is closed, the set of electrical contacts on the part mold make contact with the electrical contacts on the at least one monitoring circuit.

With the electrical contacts on the monitoring circuit in the fiber preform in electrical contact with the at least one set of contacts on the surface of the mold, the electrical resistance of the at least one monitoring circuit can be measured via the at least one set of electrical contacts on the surface of the mold. The change of the resistance of the monitoring circuits, together with information about the mold cavity geometry and resin flow path and resin properties allows the determination of the location of a resin flow front during resin transfer molding of composite parts.

Embodiments of this disclosure also provide methods of resin transfer molding of composite parts, and in particular methods of resin flow front detection during resin transfer molding of composite parts. According to a third embodiment of this disclosure, a method of molding a composite part comprises inserting a part preform into a mold cavity. The preform includes at least one monitoring circuit whose resistance changes as it is surrounded by resin. The method further includes injecting resin into the mold under pressure, and measuring the resistance of the monitoring circuit while the resin is being injected. The location of the resin flow front can then be estimated based at least in part on the measured resistance of the monitoring circuit. Optionally, one or more parameters of the molding process can be adjusted based upon the estimated resin flow front in the mold resulting from the measured resistance data.

### BRIEF DESCRIPTION OF THE DRAWINGS

The present disclosure will become more fully understood from the detailed description and the accompanying drawings, wherein:

FIG. 1 is a schematic diagram of a composite part preform in a mold as resin is being injected into the mold;

FIG. 2 is a schematic diagram of a composite part preform in a mold as resin is being injected into the mold as shown in FIG. 1, after additional resin has been injected into the mold;

FIG. 3 is a schematic diagram of a composite part preform in a mold as resin is being injected into the mold as shown in FIG. 2, after additional resin has been injected into the mold;

FIG. 4 is a schematic diagram of a composite part preform in a mold as resin is being injected into the mold as shown in FIG. 3, after additional resin has been injected into the mold;

FIG. 5 is a schematic diagram of a composite part preform in a mold as resin is being injected into the mold;

FIG. 6 is a schematic diagram of a composite part preform in a mold as resin is being injected into the mold as shown in FIG. 5, after additional resin has been injected into the mold;

FIG. 7 is a schematic diagram of a composite part preform in a mold as resin is being injected into the mold as shown in FIG. 6, after additional resin has been injected into the mold;

FIG. 8 is a schematic diagram of a composite part preform in a mold as resin is being injected into the mold;

FIG. 9 is a schematic diagram of a composite part preform in a mold as resin is being injected into the mold as shown in FIG. 8, after additional resin has been injected into the mold;

FIG. 10 is a schematic diagram of a composite part preform in a mold as resin is being injected into the mold as shown in FIG. 9, after additional resin has been injected into the mold;

FIG. 11 is a schematic diagram showing the layers in assembled to make a part preform in accordance with the principles of this disclosure;

FIG. 12 is a schematic diagram showing the assembled layers aligned with a preform tool;

FIG. 13 is a schematic diagram showing the assembled layers being shaped by the preform tool;

FIG. 14 is a schematic diagram showing the completed preform in the preform tool;

FIG. 15 is a side elevation view of the completed preform;

FIG. 16 is a schematic view of a part preform seated in the bottom portion of an open mold;

FIG. 17 is a schematic view of a part preform seated in a closed mold, ready for injection of resin;

FIG. 18 is a schematic view of a completed part in a closed mold;

FIG. 19 is a schematic view of a completed part in an open mold;

FIG. 20 is a schematic view a monitoring circuit incorporated into a preform, in which the configuration of the circuit changes across the preform, to provide increased resolution of the location of the resin flow front toward the end of the fill cycle; and

FIG. 21 is a schematic view of a plurality of monitoring circuits arranged in overlapping fashion to provide finer resolution of the location of the resin flow front during filling.

In the drawings, reference numbers may be reused to identify similar and/or identical elements.

### DETAILED DESCRIPTION

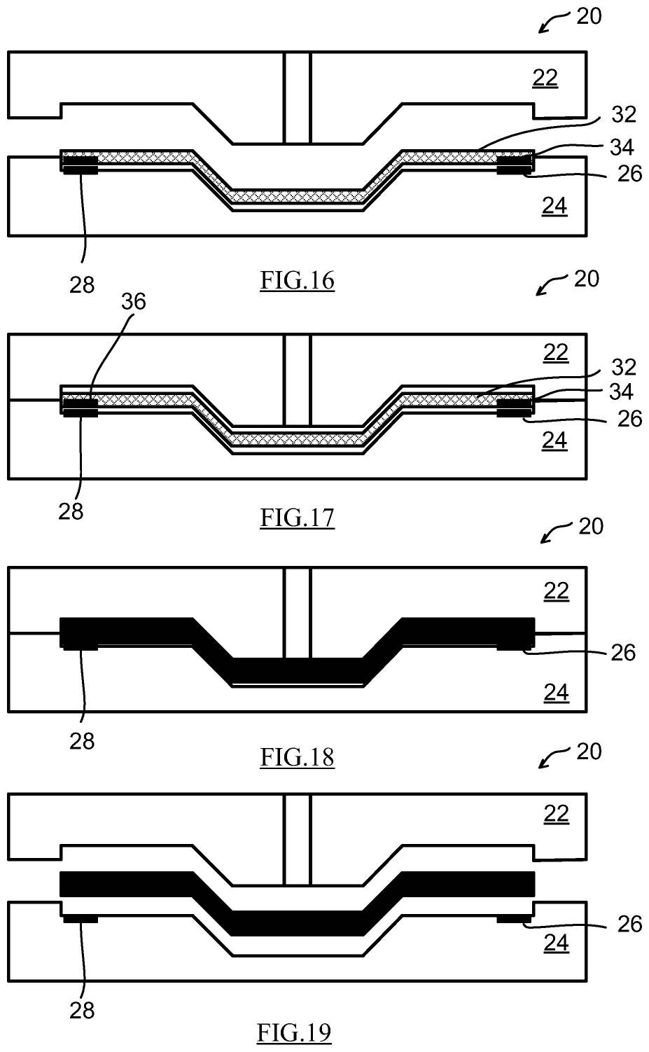

Embodiments of this disclosure provide systems for resin flow front detection during resin transfer molding of composite parts. A system according to a first embodiment of this disclosure is indicated generally as 20 in FIGS. 16-19. The system 20 comprises a part mold 22 having a plurality of mold sections 22 and 24 that are operatable between an open configuration (FIGS. 16, 19) and an operational or closed configuration (FIGS. 17, 18) in which the mold sections form a mold cavity with an internal surface substantially in the shape of the composite part. To ensure complete formation of the part, the mold may intentionally include excess volumes to accommodate an overfill, which portions can be trimmed to form the final part.

There is preferably at least one set of electrical contacts 26, 28 on the internal surface of the mold cavity for making electrical contact with at least one monitoring circuit that can be positioned inside the mold cavity. This monitoring circuit can be incorporated into, but electrically isolated from, a fibrous composite part preform 32 that can be placed into the mold cavity prior to the injection of the resin.

An electrical resistance measurement circuit 30 can be connected to the at least one set of electrical contacts 34, 36 to measure the electrical resistance of the monitoring circuit in the mold cavity connected to the set of electrical contacts 26, 28 on the surface of the mold cavity. The resistance of the monitoring circuits has been found to change as resin is injected into the mold cavity and contacts the monitoring circuits. In at least some embodiments, the change (reduction) in resistance is a result of portions of the monitoring circuit being short-circuited by the injected resin surrounding portions of the monitoring circuit. The change of the resistance of the monitoring circuits alone or together with other data such as information about the mold cavity geometry and orientation, and resin flow path and resin properties, allows the determination of the location of the resin flow front during resin transfer molding of composite parts.

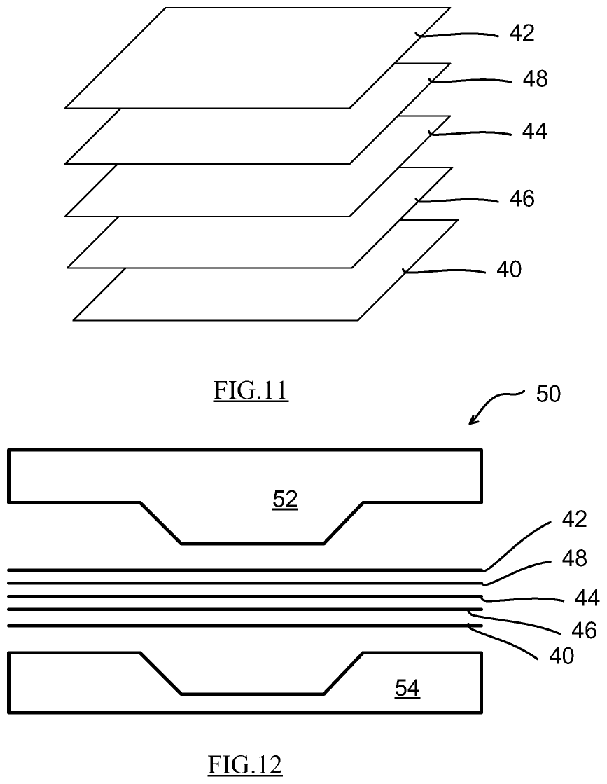

The fabrication of the part preform 32 is illustrated in FIGS. 11-15. As shown in FIG. 11, a plurality layers are assembled. The layers can include carbon fiber matts or scrims 40 and 42, a layer 44 including a monitoring circuit 30, and layers 46 and 48 for electrically isolating the monitoring circuit from the conductive carbon fiber layers, to help ensure that changes in resistance of the monitoring circuit are due to the presence of resin, and not contact with other support layers. The five layers are simply illustrative of a possible construction, and the actual preform can comprise additional layers, and layers of different materials appropriate for the finished part. For example, the layers can also include other materials, such as fiber glass, polymers, or other suitable materials.

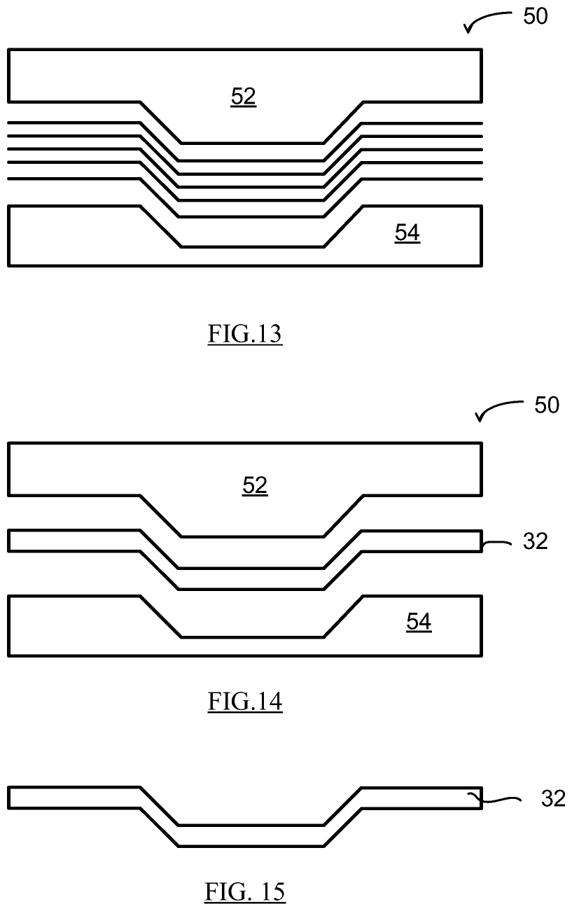

As shown in FIG. 12, the layers for the preform are aligned with a preform tool 50, comprising upper and lower portions which as shown in FIG. 13 can be compressed to compress the layers together. The layers may be held together mechanically by deformation of the layers, or binders can be used to help the layers stay together, and/or help the preform maintain its desired shape. These binders can be chemically activated, heat activated, or photoactivated. As part of the fabrication of the preform 32, electrical contacts such as contacts 34, 36 can be formed in or on the surface of the preform, in electrical connection with the at least one monitoring circuit. Where multiple monitoring circuits are provided, each preferably has its own electrical contacts so that the changes in resistance of each monitoring circuit can be separately measured. The preform tool 50 preferably helps properly position the electrically contacts on the preform 32 during assembly, so that when the preform is properly seated in its appropriate mold, the contacts on the preform align with the corresponding sets of contacts on the mold sections.

According to a second embodiment of this disclosure, the system comprises a part mold 20 and fiber part preform 32 disposed therein. The mold can comprise a plurality of mold sections e.g., sections 22 and 24 which together define an interior mold cavity with a surface substantially corresponding to the shape of a composite part to be manufactured. The part mold 20 can have at least one set of electrical contacts 26, 28 on the inside surface of the part mold. A fiber preform 32 for the composite part is disposed in the mold cavity, and includes a plurality of reinforcing fibers and at least one monitoring circuit 30 whose resistance changes as it is surrounded by resin.

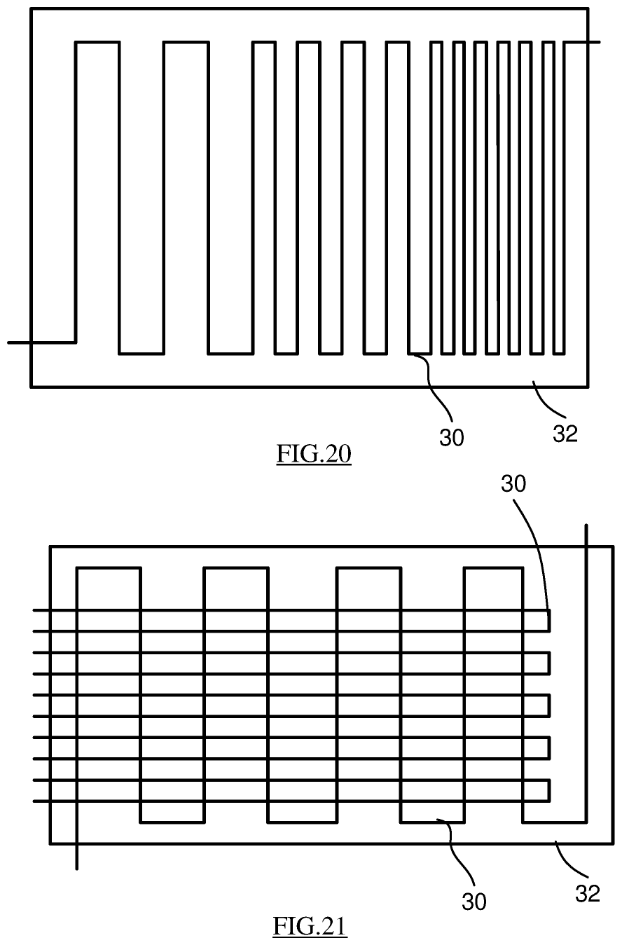

The at least one monitoring circuit 30 can be made of a metal or metal alloy or carbon fiber of other material that provides a measurable resistance in a convenient range. The resistance of the monitoring circuit 30 changes as it is surrounded by resin, which itself can be electrically conductive, so that the reduction in resistance as the resin short circuits the path of the monitoring circuit 30 indicating the location of the resin flow front. The monitoring circuit has electrical contacts 34, 36 positioned on the preform 32 so that when the preform is properly seated in the mold cavity, and the mold closed, the set of electrical contacts 26, 28 on the part mold make contact with the electrical contacts 34, 36 on the at least one monitoring circuit. Multiple monitoring circuits 30 can be provided in the preform, as illustrated in FIGS. 20 and 21, and the electrical contacts on these circuits and on the mold are arranged so that the resistance in each of the circuits 30 can be separately monitored.

With the electrical contacts 34, 46 on the monitoring circuit 30 in electrical contact with the at least one set of contacts 26, 28 on the surface of the mold, the electrical resistance of the at least one monitoring circuit can be measured via the at least one set of electrical contacts on the mold. The change of the resistance of the monitoring circuits 30, together with information about the mold cavity geometry and resin flow path and properties allows the determination of the location of the resin flow front during resin transfer molding of composite parts.

Embodiments of this disclosure also provide methods of resin transfer molding composite parts, and in particular methods of resin flow front detection during resin transfer molding of composite parts. According to a third embodiment of this disclosure, a method of molding a composite part comprises inserting a part preform 32 into the cavity of a mold 20. The preform includes at least one monitoring circuit 30 whose resistance changes as it is surrounded by resin. The method further includes injecting resin into the mold 20 under pressure, and measuring the resistance of the monitoring circuit or circuits 30 while the resin is being injected. The location of the resin flow front during the injection can then be estimated based at least in part on the measured resistance of the monitoring circuit. Optionally, one or more parameters of the molding process, such as resin injection pressure, the identity of the injection sites used, the volume of resin injected based upon the feedback of resin flow front provided.

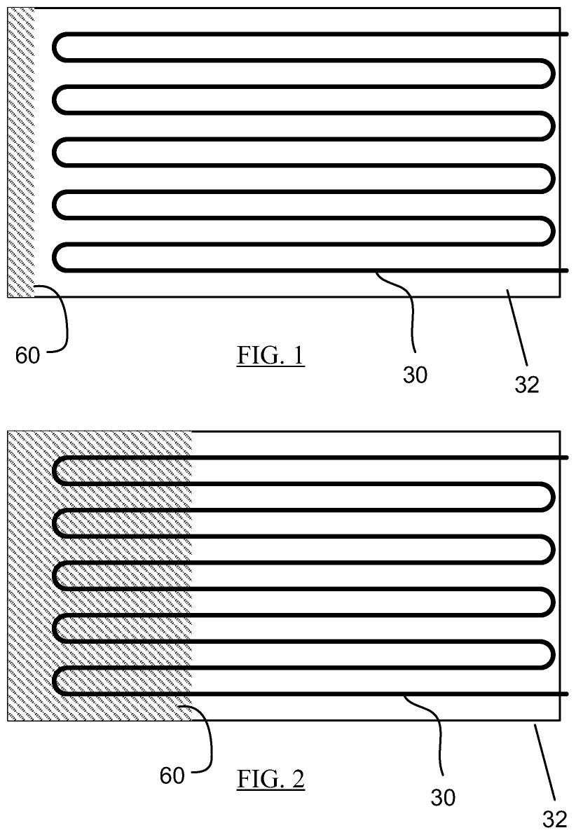

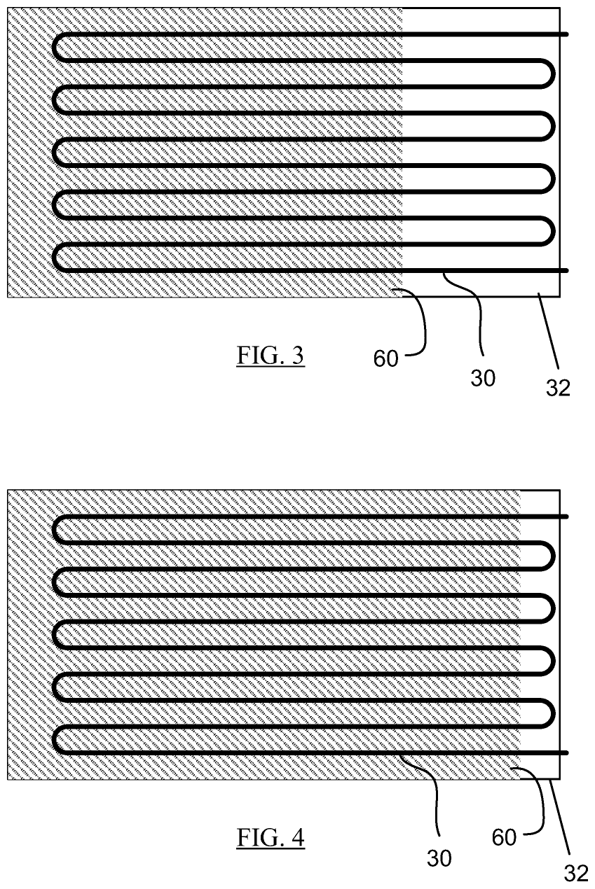

The operation of the system and method are illustrated in FIGS. 1-4, where a part preform 32 is shown with a monitoring circuit 30 with a generally serpentine configuration is shown. As shown in FIG. 1, when the resin flow front 60 has not reached the circuit 30, the circuit's resistance remains unchanged, indicating the front has not progressed to the location of the circuit. As shown in FIG. 2, once the resin flow front reaches the circuit 30, parts of the circuit are short-circuited, reducing the circuit's resistance and indicating that resin flow front 60 has advanced partway across the circuit 30. As shown in FIG. 3 even more of the circuit 30 has been short circuited, with a corresponding reduction of resistance that indicated the more advanced position of the resin flow front 60. Finally, in FIG. 4, the resin has advanced even further, short circuiting even more of the circuit than in FIG. 3, and indicated that the filling of the mold is nearly complete, and that the resin flow front 60 has advanced almost completely across the circuit.

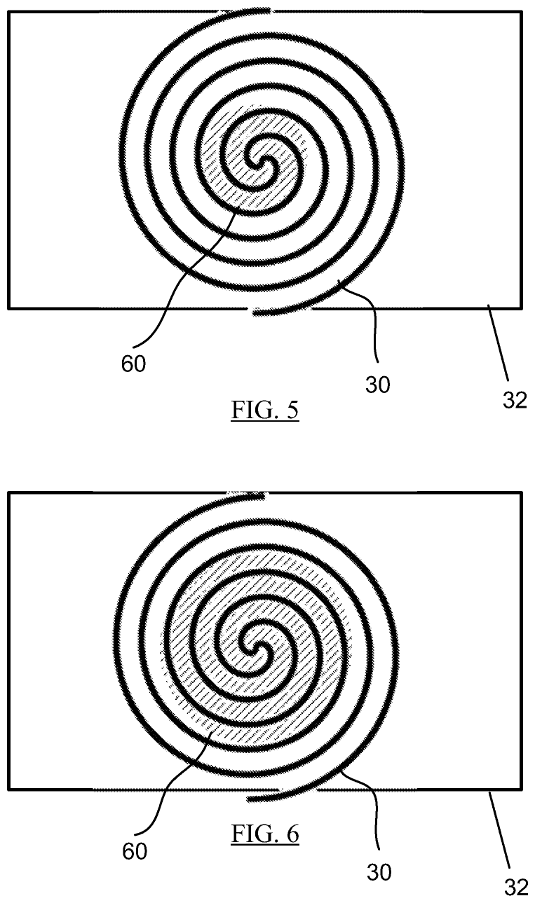

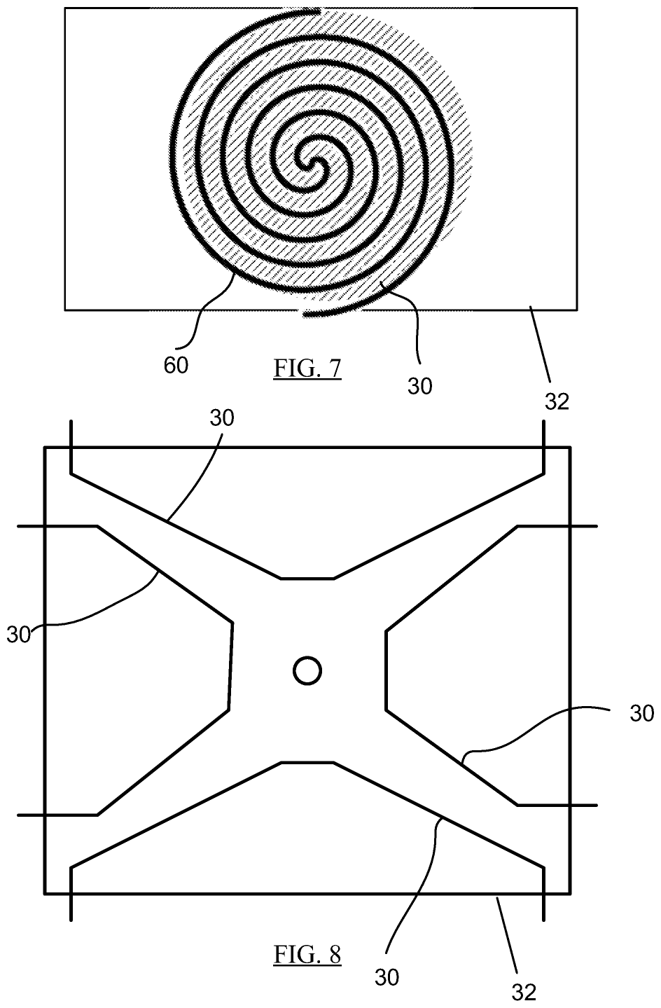

Similarly, the operating of the system and method are also illustrated in FIGS. 5-7, where a part preform 32 includes a spiral monitoring circuit 30. The injection point in this example is at the center of the spiral. As shown in FIG. 5, as injection of resin begins, the resin begins to surround the center of the spiral, short circuiting the portion of the circuit in the center of the spiral, and reducing the overall resistance of the circuit. This indicates that the resin flow front is still near the center of the circuit (and the center of the preform in the mold). As shown in FIG. 6, continued filling of the mold cavity causes the resin flow font 60 to advance outwardly from the center of the mold cavity, short circuiting more of the monitoring circuit 30, reducing the monitoring circuit's measured resistance, and indicating that the resin flow front is intermediate the center and the outside edge of the circuit. Then in FIG. 7, the resin flow front 60 has advanced even further, and the corresponding reduction in resistance indicates that the resin flow front 60 is adjacent to the outer edge of the circuit.

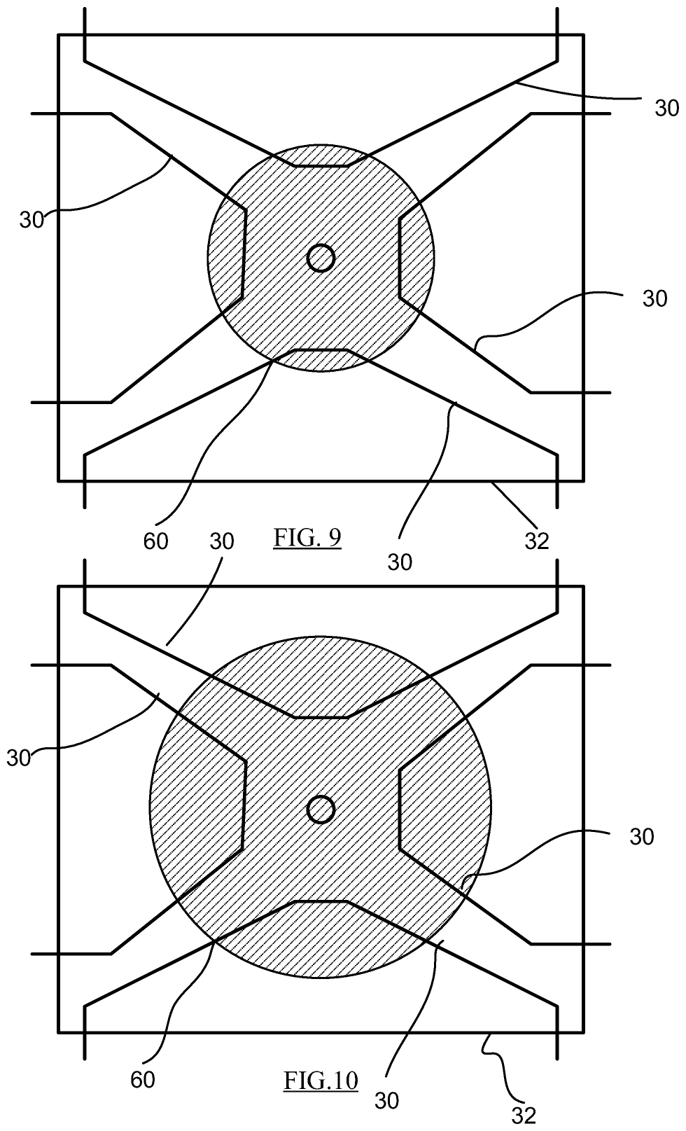

Similarly, the operation of the system and method are also illustrated in FIGS. 8-10, where a part preform 32 includes four monitoring circuits 30. The injection point of the resin in this example is at the center of the preform 32. As shown in FIG. 8, before injection begins the resistance of the circuits is unchanged, indicating that the injection has not begun or at least that it has not advanced far. As shown in FIG. 9, the resin flow front 60 has advanced to reach each of the circuits 30, reducing each circuit's resistance. This indicates that the resin flow front is still near the center of the circuit (and the center of the preform in the mold. As shown in FIG. 9, continued filling of the mold cavity causes the resin flow front 60 to advance outwardly from the center of the mold cavity, short circuiting more of the monitoring circuits 30, reducing the circuits' measured resistances, and indicating that the resin flow front is intermediate the center and the outside edge of the preform. The relative changes in the resistances of the four monitoring circuits indicates the shape of the resin flow front 60. Then in FIG. 10, the resin flow front 60 has advanced even further toward the edges of the preform 32, and the corresponding reduction in resistances in the four monitoring circuits 30 indicates that the resin flow front 60 is closer to the outer edge of the circuits and of the preform.

As shown in FIG. 20, the shape of the monitoring circuit 30 can vary, in this case with an increasing number of more closely spaced loops, in order to provide finer resolution of the resin flow front, as the resin fills the cavity from left to right as shown in the Figure.

As shown in FIG. 21 multiple monitoring circuits 30 can be arranged in overlapping fashion to provide fine resolution of the location of the resin flow front, in this case as the resin flows into the mold and across the preform 32 from right to left.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is:

1. A system for making composite parts, the system comprising:
a part mold having a plurality of mold sections, operatable between an open configuration and an operational configuration in which the mold sections form a mold cavity having a surface substantially in the shape of the composite part;
at least one set of electrical contacts on the surface of the mold cavity for making electrical contact with a monitoring circuit positioned inside the mold cavity;
at least one electrical resistance monitoring circuit electrically connected to the at least one set of electrical contacts on the surface of the mold cavity for measuring the electrical resistance of the at least one monitoring circuit connected to the at least one set of electrical contacts on the surface of the mold cavity; and
a processor for estimating a location of a flow front of resin injected into the mold cavity, based at least in part on electrical resistance measurements of the at least one monitoring circuit.

2. The system according to claim 1 wherein the at least one monitoring circuit is incorporated into a reinforcing preform disposed in the mold.

3. The system according to claim 2 wherein the fiber reinforcing preform comprises barrier layers electrically isolating the at least one monitoring circuit from the fiber reinforcing preform.

4. The system according to claim 2 where there are multiple monitoring circuits incorporated into the fiber reinforcing preform.

5. The system according to claim 4 wherein portions of multiple monitoring circuits overlap.

6. The system according to claim 2 wherein the configuration of the monitoring circuit changes in the direction of anticipated flow of resin in the mold cavity.

7. In combination with a part mold for the resin transfer molding of a composite part, the part mold comprising a plurality of mold sections which together define an interior cavity having an interior surface substantially corresponding to the shape of the composite part to be manufactured, the part mold having at least one set of electrical contacts on its surface, a fiber preform for the composite part, the fiber preform including a plurality of reinforcing fibers and at least one monitoring circuit whose resistance changes in the presence of resin, the at least one monitoring circuit having electrical contacts positioned on the fiber preform so that when the preform is disposed in the mold cavity, the electrical contacts of the at least one monitoring circuit are in electrical contact with the at least one set of electrical contacts on the interior surface of the mold, so that the electrical resistance of the at least one monitoring circuit can be measured via the set of electrical contacts on the surface of the mold.

8. The combination according to claim 7 wherein the fiber perform further comprises barrier layers electrically isolating the at least one monitoring circuit from the fiber preform.

9. The combination according to claim 7 wherein the fiber preform comprises a plurality of monitoring circuits.

10. The combination according to claim 9 wherein portions of the plurality of monitoring circuits overlap.

11. The combination according to claim 7 wherein the configuration of a monitoring circuit changes in the direction of anticipated flow of resin in the mold cavity.

12. A method of molding a fiber reinforced composite part, the method comprising the steps of:
inserting a fiber preform into a mold cavity, the preform including at least one monitoring circuit whose resistance changes as it is surrounded with resin;
injecting resin into the mold under pressure;
measuring the resistance of the at least one monitoring circuit; and
estimating a location of a resin flow front in the mold using the measured resistance data.

13. The method according to claim 12 further comprising the changing at least one parameter of the molding process in response to the estimated location of a resin flow front.

14. The method according to claim 12 wherein the mold has at least first and second electrical contacts, and wherein the at least one monitoring circuit has first and second electrical contacts positioned on the preform to engage the first and second electrical contacts on the mold, and wherein the resistance of the monitoring circuit is measured by measuring the electrical resistance between the first and second electrical contacts on the mold.

15. The method according to claim 12 wherein the fiber preform includes a plurality of monitoring circuits.

16. The method according to claim 15 wherein at least some of the plurality of monitoring circuits at least partially overlap with each other.

17. The method according to claim 12 wherein the configuration of the monitoring circuit changes in the anticipated direction of flow of resin.

18. The method according to claim 12 wherein the step of estimating the location of a resin flow front is based in part on at least one of the geometry of the mold, the flow properties of the resin, and the anticipated direction of flow or resin in the mold.
